(19) United States
(12) Patent Application Publication
(10) Pub. No.: US 2004/0122749 A1
(43) Pub. Date: Jun. 24, 2004

(54) System and method for managing manufacturing orders

(76) Inventor: Hung-Shan Wei, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/405,735

(22) Filed: Apr. 1, 2003

(30) Foreign Application Priority Data
Dec. 20, 2002 (TW) 91136949

(51) Int. Cl. G06F 17/60

(52) U.S. Cl. 705/28

(57) ABSTRACT

A system for managing manufacturing orders includes an order generating module (201), an order shifting module (202), an order performing module (203), and a document updating module (205). The order generating module is used to generate a new manufacturing order. The order shifting module adds data on an original manufacturing order to the new manufacturing order. The order performing module is used to terminate the original manufacturing order. The document updating module is used to update a master list of manufacturing orders, detailed records of manufacturing orders and planning bills of material (BOMs). A related method includes: (a) receiving original manufacturing orders needing combination; (b) generating a new manufacturing order, a corresponding new detailed record of a manufacturing order and a corresponding new planning BOM; (c) adding data on original manufacturing orders to the new manufacturing order; (d) terminating the original manufacturing orders; and (e) releasing the new manufacturing order.

### BACKGROUND OF THE INVENTION

1. Field of the Invention

The present invention relates to a computer data process system in the manufacturing industry, and especially to a system and method for managing manufacturing orders via distributed computers.

2. Background of the Invention

Globalized economic development has brought tremendous business opportunities to numerous enterprises, and also brought more pressure to bear on manufacturing enterprises. For example, more and more customized products are being ordered by a wider range of customers, and customers are requiring more rigorous quality standards and more demanding delivery deadlines. Further, an enterprise's manufacturing may be conducted in a number of different countries across the globe, making management of the enterprise a challenging task. A competitive enterprise needs to adopt new technologies, design new products, reduce manufacturing cycles of products, enhance productivity, and reduce costs. Such enterprise should also strengthen manufacturing management, such as supply of materials, product manufacturing, and merchandise distribution. The enterprise should further cooperate with suppliers, dealers, and customers to make the best of their shared and respective resources. By such means, the enterprise can achieve high customer satisfaction, and maintain keen competitiveness.

Manufacturing resource planning (MRPII) systems can assist in advancing an enterprise's competitiveness. For example, P.R.China patent application No. 01118171.0 entitled “System for Manufacturing Management” discloses an information system for manufacturing management. In this system, a network is used to connect a central processing device with a plurality of terminal devices. The central processing device processes data from the terminal devices, and sends management information to the terminal devices to manage manufacturing on a shop floor. The system can help the enterprise manufacture high quality products, enhance productivity, reduce costs of resources, and shorten manufacturing life cycles.

However, changes in a manufacturing schedule can occur at any time and for any of a variety of reasons. For example, a customer may changes its orders, a supplier may change delivery times of materials, and manufacturing machinery may break down or function poorly. The enterprise may not be able to keep to its original fixed production plan. In these circumstances, the above-described information system for manufacturing management is of little value. To maintain enhanced productivity, an enterprise needs to be able to flexibly change production planning according to commercial vicissitudes.

### SUMMARY OF THE INVENTION

Accordingly, an objective of the present invention is to provide a system for managing manufacturing orders which can convert a plurality of manufacturing orders into a new manufacturing order to adapt to changes in manufacturing order circumstances.

Another objective of the present invention is to provide a method for managing manufacturing orders which can convert a plurality of manufacturing orders into a new manufacturing order to adapt to changes in manufacturing order circumstances.

In order to achieve the first above-mentioned objective, a system for managing manufacturing orders in accordance with the present invention comprises an order generating module, an order shifting module, an order performing module and a document updating module. The order generating module is used to generate a new manufacturing order, the new manufacturing order corresponding to a new detailed record of a manufacturing order and a new planning bill of material (BOM). The order shifting module adds data on an original detailed record of a manufacturing order to the new detailed record of a manufacturing order, and adds data on an original planning BOM to the new planning BOM. The order performing module is used to terminate an original manufacturing order. The document updating module is used to update a master list of manufacturing orders, detailed records of manufacturing orders and planning BOMs.

In order to achieve the second above-mentioned objective, a method for managing manufacturing orders in accordance with the present invention comprises the steps of: (a) receiving from a user original manufacturing orders needing combination; (b) generating a new manufacturing order, a corresponding new detailed record of a manufacturing order and a corresponding new planning bill of material (BOM); (c) adding data on the original manufacturing orders to the new manufacturing order; (d) terminating the original manufacturing orders; and (e) releasing the new manufacturing order.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for managing manufacturing orders in accordance with a preferred embodiment of the present invention, the system comprising a plurality of client computers, an application server, and a database server;

FIG. 2 is a block diagram of function modules of the application server and the database server, and of communication between the application server and the database server;

FIG. 3 is a flow chart of combining a plurality of original manufacturing orders into a new manufacturing order in accordance with a preferred embodiment of the present invention; and

FIG. 4 is a flow chart of details of two steps of FIG. 3, namely adding data on original manufacturing order to a new manufacturing order, and terminating the original manufacturing order.

### DETAILED DESCRIPTION OF PREFERRED EMBODIMENTS OF THE INVENTION

Reference will now be made to the drawings to describe the present invention in detail.

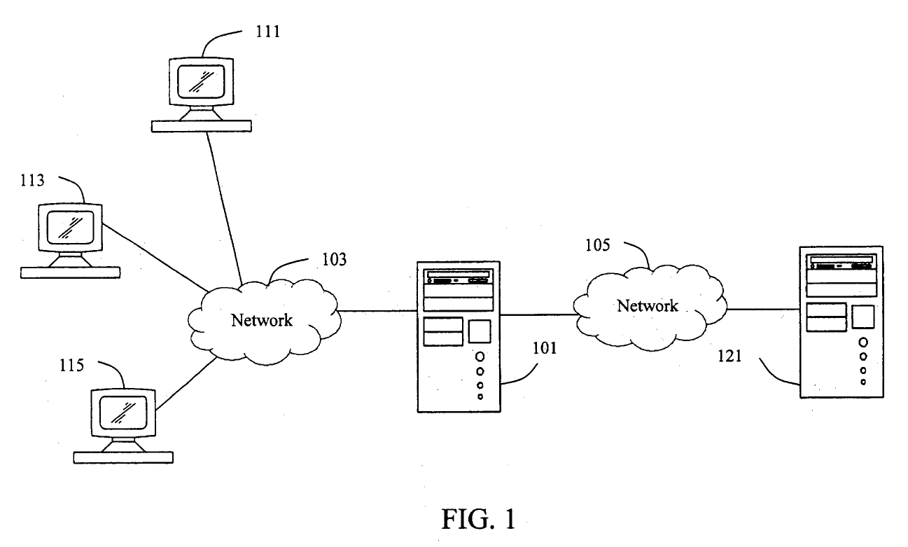

FIG. 1 is a schematic diagram of hardware configuration of a system for managing manufacturing orders in accordance with a preferred embodiment of the present invention. The system for managing manufacturing orders comprises a three-layer information system. The three-layer information system comprises a data access layer, a business logic layer, and a presentation layer. The data access layer comprises a database server 121. The business logic layer comprises an application server 101. The presentation layer comprises a plurality of client computers. For the purposes of conveniently illustrating the preferred embodiment of the present invention, three client computers 111, 113, 115 are shown and described hereinafter. Computer communication networks 103, 105 interconnect all the above-mentioned apparatuses.

The application server 101 comprises core and mutable enterprise logic (such as rules, execution, and management) of the system for displaying patent analysis information. The application server 101 processes input of users, and returns results of processing to users. The database server 121 has a database located therein, which stores all structured data on an enterprise. The database server 121 is used for managing processing of the stored data. Such processing includes reading, writing, deleting, modifying, and backup. The client computers 111, 113, 115 have the function of receiving orders input by users, and displaying results of implementation of such orders. The client computers 111, 113, 115 can be simple input/output devices.

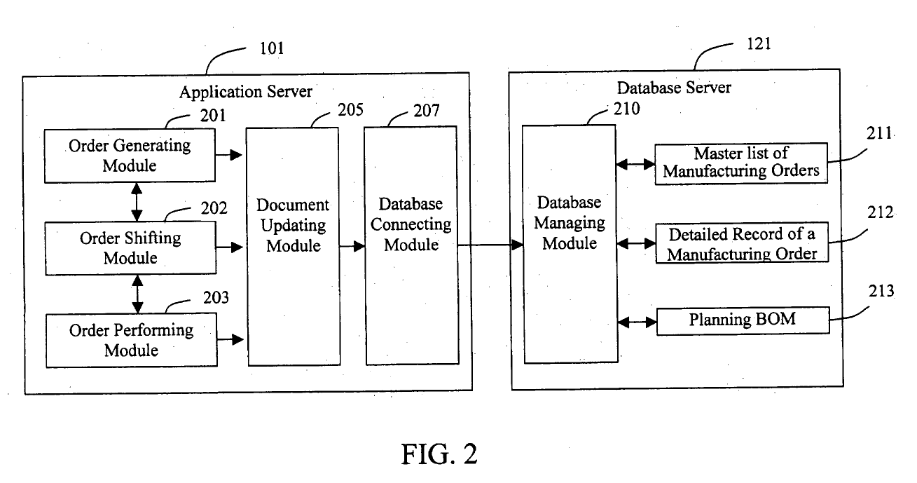

FIG. 2 is a block diagram of function modules of the application server 101 and the database server 121, and of communication between the application server 101 and the database server 121. The application server 101 includes an order generating module 201, an order shifting module 202, an order performing module 203, a document updating module 205, and a database connecting module 207. The database server 121 includes a database managing module 210, a master list of manufacturing orders 211, a plurality of detailed records of manufacturing orders 212 (only one shown), and a plurality of planning BOMs (bills of material) 213 (only one shown). Each manufacturing order corresponds to one detailed record of manufacturing orders 212 and one planning BOM 213. In the preferred embodiment of the present invention, each manufacturing order is an order to a shop floor to manufacture a fixed quantity of designated products within a fixed time.

The master list of manufacturing orders 211 comprises the following data on each manufacturing order: data on an ID of the manufacturing order, a category of the manufacturing order, a code of an enterprise, quantities of products, modes of manufacturing scheduling, and a status of the manufacturing order. Modes of manufacturing scheduling refers to different ways in which the same product or similar products are made. For example, a product may be made by adding on successive components in a particular sequence. The same or a similar product may also be made by adding on the same components successively, but in a different sequence. Each detailed document of a manufacturing order 212 comprises data on an ID of the manufacturing order, quantities of products, scheduled manufacturing output, scheduled manufacturing starting times, stock storage after manufacturing, actual manufacturing starting times, actual manufacturing completion times, a total quantity upon completion of manufacturing, and a quantity of residue stock of unsatisfactory quality. Each planning BOM 213 comprises data on an ID of a corresponding manufacturing order, codes of materials, a storage code, and a quantities of the materials.

The order generating module 201 is used to generate new manufacturing orders. Each new manufacturing order corresponds to an existing detailed record of a manufacturing order 212 and an existing planning BOM 213. The order shifting module 202 is used to shift data stored in one detailed record of a manufacturing order 212 to another detailed record of a manufacturing order 212 of another designated manufacturing order, and to update corresponding data stored in the master list of manufacturing orders 211 and the corresponding planning BOM 213. The order performing module 203 is used to terminate any designated manufacturing order. When a manufacturing order is terminated, the master list of manufacturing orders 211 is updated, and the corresponding original detailed record of a manufacturing order 212 and planning BOM 213 are deleted. The document updating module 205 is used to update data stored in the database server 121 in accordance with information generated by the order generating module 201, the order shifting module 202, and the order performing module 203 via the database connecting module 207 and the database managing module 210.

The database connecting module 207 is used for connecting the application server 101 with the database server 121. The database connecting module 207 controls data communication between applications and source data. Applications of the application server 101 can access data stored in different database management systems (DBMSs) via the database connecting module 207. The database connecting module 207 can be based on open database connectivity (ODBC). The database managing module 210 is used to manage data stored in the database server 121, including data stored in the master list of manufacturing orders 211, the detailed records of manufacturing orders 212, and the planning BOMs 213.

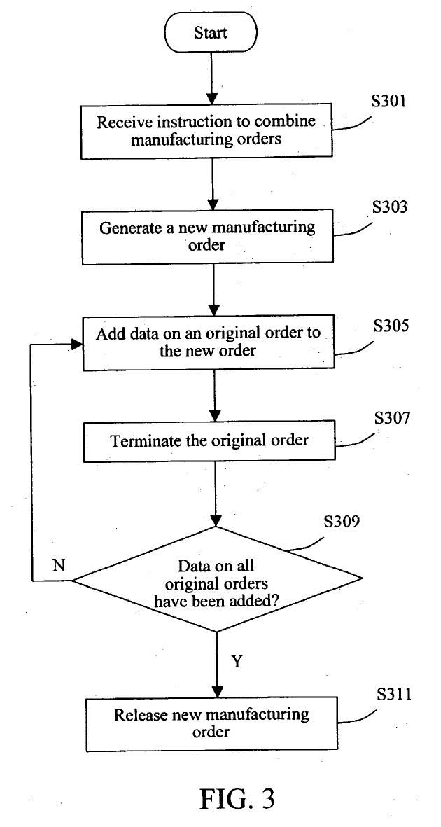

FIG. 3 is a flow chart of combining a plurality of original manufacturing orders into a new manufacturing order in accordance with a preferred embodiment of the present invention. Firstly, in step S301, the application server 101 receives an instruction from any of the client computers 111, 113, 115 to combine designated manufacturing orders. In step S303, the order generating module 201 generates a new manufacturing order. A corresponding new detailed record of a manufacturing order 212 and a corresponding new planning BOM 213 are generated too. The document updating module 205 adds the new manufacturing order to the master list of manufacturing orders 211, and adds the new detailed record of a manufacturing order 212 and new planning BOM 213 into the database server 121. The new detailed record of a manufacturing order 212 and the new planning BOM 213 are empty.

In step S305, the order shifting module 202 reads an original manufacturing order needing combination into the master list of manufacturing orders 211, adds data stored in a corresponding original detailed record of a manufacturing order 212 to the new detailed record of a manufacturing order 212, and adds data stored in a corresponding original planning BOM 213 to the new planning BOM 213. In step S307, the order performing module 203 terminates the original manufacturing order. The original manufacturing order is deleted from the master list of manufacturing orders 211, and the corresponding original detailed record of a manufacturing order 212 and planning BOM 213 are deleted too.

In step S309, the order shifting module 202 determines whether all data on the original manufacturing orders needing combination have been added to the new manufacturing order in accordance with the master list of manufacturing orders 211. If any of said data have not yet been added, the procedure returns to step S305. If and when all said data have been added, in step S311, the new manufacturing order is released.

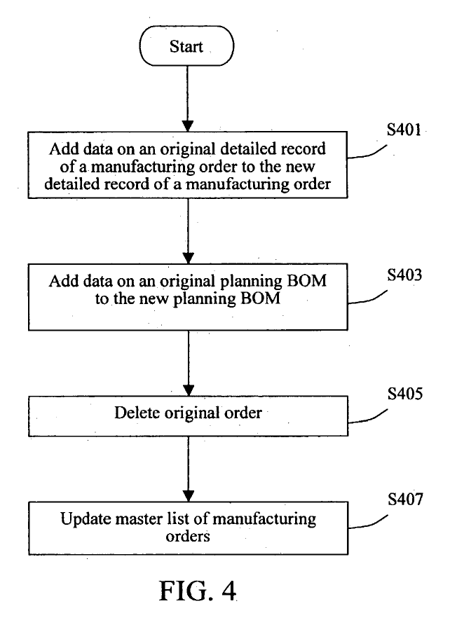

FIG. 4 is a flow chart of details of steps S305 and S307 of FIG. 3, namely adding data on an original manufacturing order to a new manufacturing order, and terminating the original manufacturing order. In step S401, the document updating module 205 adds data on the original detailed record of a manufacturing order 212 to the new detailed record of a manufacturing order 212 in accordance with an instruction for updating the new detailed record of a manufacturing order 212 made by the order shifting module 202. In step S403, the document updating module 205 adds data on the original planning BOM 213 to the new planning BOM 213. In step S405, the document updating module 205 deletes the original detailed record of a manufacturing order 212 and planning BOM 213. In step S407, the document updating module 205 deletes the original manufacturing order in the master list of manufacturing orders 211.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for managing manufacturing orders, the system comprising an order generating module, an order shifting module, an order performing module and a document updating module, wherein:
the order generating module is used to generate a new manufacturing order, the new manufacturing order corresponding to a new detailed record of a manufacturing order and a new planning bill of material (BOM);
the order shifting module adds data on an original detailed record of a manufacturing order to the new detailed record of a manufacturing order, and adds data on an original planning BOM to the new planning BOM;
the order performing module is used to terminate an original manufacturing order; and
the document updating module is used to update a master list of manufacturing orders, detailed records of manufacturing orders and planning BOMs.

2. The system as claimed in claim 1, wherein the order generating module, the order shifting module, the order performing module and the document updating module are comprised in an application server.

3. The system as claimed in claim 1, further comprising a database connecting module which connects the order generating module, the order shifting module, the order performing module and the document updating module with the master list of manufacturing orders, the detailed records of manufacturing orders and the planning BOMs for data interchange there between.

4. The system as claimed in claim 1, wherein the master list of manufacturing orders, the detailed records of manufacturing orders and the planning BOMs are comprised in a database server.

5. The system as claimed in claim 1, wherein the document updating module updates the master list of manufacturing orders, the detailed records of manufacturing orders and the planning BOMs in accordance with implemented results of the order generating module, the order shifting module and the order performing module.

6. A method for managing manufacturing orders, the method comprising the steps of:
receiving from a user original manufacturing orders needing combination;
generating a new manufacturing order, a corresponding new detailed record of a manufacturing order and a corresponding new planning bill of material (BOM);
adding data on the original manufacturing orders to the new manufacturing order;
terminating the original manufacturing orders; and
releasing the new manufacturing order.

7. The method as claimed in claim 6, wherein the step of adding data further comprises the steps of:
adding data on original detailed records of the original manufacturing order to the new detailed record of a manufacturing order; and
adding data on original planning BOMs to the new planning BOM.

8. The method as claimed in claim 6, wherein the step of terminating the original manufacturing orders further comprises the steps of:
deleting original detailed records of the original manufacturing order; and
deleting the original manufacturing order in a master list of manufacturing orders.

9. A system for managing manufacturing orders comprising:
means for generating a new manufacturing order, the new manufacturing order corresponding to a new detailed record of a manufacturing order and a new planning bill of material (BOM);
means for adding data on an original detailed record of a manufacturing order to the new detailed record of a manufacturing order, and adding data on an original planning BOM to the new planning BOM;
means for terminating an original manufacturing order; wherein
said means for generating a new manufacturing order is automatically generated by the system or manually keyed in.
